(19) United States
(12) Patent Application Publication
(10) Pub. No.: US 2015/0381704 A1
(43) Pub. Date: Dec. 31, 2015

(54) MECHANISM FOR FILE TRANSFORMATION AND SHARING ACROSS DEVICES USING CAMERA INTERFACE

(71) Applicants: Saurabh Dadu, Tigard, OR (US); Rajesh Poornachandran, Portland, OR (US); Ravikiran Chukka, Portland, OR (US); Ashok K. Mishra, Portland, OR (US)

(72) Inventors: Saurabh Dadu, Tigard, OR (US); Rajesh Poornachandran, Portland, OR (US); Ravikiran Chukka, Portland, OR (US); Ashok K. Mishra, Portland, OR (US)

(21) Appl. No.: 14/317,250

(22) Filed: Jun. 27, 2014

(51) Int. Cl. H04L 29/08; G06F 17/30; G06F 3/0484; H04W 8/24; G06F 3/0482

(52) U.S. Cl. CPC H04L 67/06; H04W 8/24; G06F 3/0482; G06F 3/04842; G06F 17/30076

(57) ABSTRACT

Embodiments described herein relate generally to the transmission of a request for a file from a first computing device to a second computing device. The first computing device may present an image having a representation of a file to a user and detect a selection of a location on the image at which the representation of the file is disposed. The first computing device, in turn, may transmit the image and a description of the selection to the second computing device. Based on the received image and description of the selection, the second computing device may identify the file corresponding to the selected location on the image. The second computing device may adapt, or cause to be adapted, the identified file. The second computing device may then transmit the identified file (or the adapted version) to the first computing device. Other embodiments may be described and/or claimed.

### FIELD OF INVENTION

Embodiments of the present invention relate generally to the technical field of data processing, and more particularly, to computer systems adapted to operate to wirelessly communicate data over networks.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by their inclusion in this section.

Computer systems are generally adapted to execute a plurality of applications. These applications may be adapted to present a digital file to a user. Illustratively, a word processing application may be adapted to present a textual file to a user on a display of a computer system. Similarly, a multimedia application may be adapted to present a digital image and/or video file to a user on a display and/or through a speaker of a computer system.

In order to present such a digital file to a second user at a second computer system, the digital file may be transferred to the second computer system—e.g., via email, cloud storage, removable flash storage, etc. Existing approaches to file transfer may be cumbersome in that they require a wired connection, an intermediary computer system, or the like. Further, such approaches may be difficult for users due to the navigational process involved. For example, to transfer files between two computer systems, a user may need to navigate through the library of the hosting computer system to locate the desired file for transfer. Additionally, this approach to file transfer may require that the user know or have access to the name of the desired file. These attributes may make file transfer difficult and/or slow for a user.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they may mean at least one.

FIG. 1 is a block diagram illustrating a system for wirelessly requesting, by a portable electronic device, a file stored at a computing device, in accordance with various embodiments.

FIG. 2 is a block diagram illustrating a portable electronic device that includes a visual file requester that is to wirelessly transmit a request for a file to another computing device, in accordance with various embodiments.

FIG. 3 is a block diagram illustrating a computing device that includes a visual file provider to identify a file requested by another computing device, in accordance with various embodiments.

FIG. 4 is a block diagram illustrating a communication module to wirelessly receive and transmit files between computing devices, in accordance with various embodiments.

FIG. 5 is a block diagram illustrating wirelessly sharing a file between devices using an image of the file, in accordance with various embodiments.

FIG. 6 (Section I) is a block diagram illustrating an application that is to invoke a visual file requester to wirelessly share a file, in accordance with various embodiments.

FIG. 6 (Section II) is a block diagram illustrating a portable electronic device having a camera that is to capture an image of a file, displayed by another computing device, that is to be wirelessly shared, in accordance with various embodiments.

FIG. 7 is a flow diagram illustrating a method for requesting that a file be wirelessly transmitted from another computing device to a portable electronic device, in accordance with various embodiments.

FIG. 8 is a flow diagram illustrating a method for pairing with and transmitting characteristics of a portable electronic device to another computing device to be used to adapt a file to be wirelessly transmitted from the other computing device to the portable electronic device, in accordance with various embodiments.

FIG. 9 is a flow diagram illustrating a method for identifying a requested file and wirelessly transmitting the identified file to another computing device, in accordance with various embodiments.

FIG. 10 is a flow diagram illustrating a method for receiving characteristics of another computing device that may be used to adapt a file that is to be wirelessly transmitted to the other computing device, in accordance with various embodiments.

### DETAILED DESCRIPTION

In the following detailed description, reference is made to the accompanying drawings, which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrases “A or B” and “A and/or B” means (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the terms “module” and/or “logic” may refer to, be part of, or include an Application Specific Integrated Circuit (“ASIC”), an electronic circuit, a processor (shared, dedicated, or group), and/or memory (shared, dedicated, or group) that execute one or more software or firmware programs, a combinational logic circuit, and/or other suitable hardware components that provide the described functionality.

In various embodiments, a portable electronic device may include a visual file requester. The visual file requester may be adapted to present, on a display of the portable electronic device, an image of another display coupled with a providing computing device. The image may include a representation of a file that is hosted or otherwise stored at the providing computing device. The visual file requester may be adapted to detect a selection of a location of an image where the representation is disposed on the display of the portable electronic device. The visual file requester may then cause the image and a description of the selection (e.g., pixel coordinates on the image) to be wirelessly transmitted, via a transmitter of the portable electronic device, to the providing computing device at which the file is stored.

In response to reception of the image and the description of the selection, the providing computing device may access and/or invoke a visual file provider. The visual file provider may be adapted to identify a file stored at the providing computing device based on the received image and the description of the selection. In various embodiments, the visual file provider may be adapted to map the image to content presented on a display coupled with the providing computing device through image registration, feature detection, and/or other image processing methods associated with, for example, augmented reality. In one embodiment, the visual file provider may be adapted to access data about one or more files (e.g., metadata) and compare or otherwise match that data with the representation of the file, indicated by the description of the selection, included in the image. The visual file provider may then cause the identified file to be wirelessly transmitted, via a transmitter coupled with the providing computing device, to the portable electronic device.

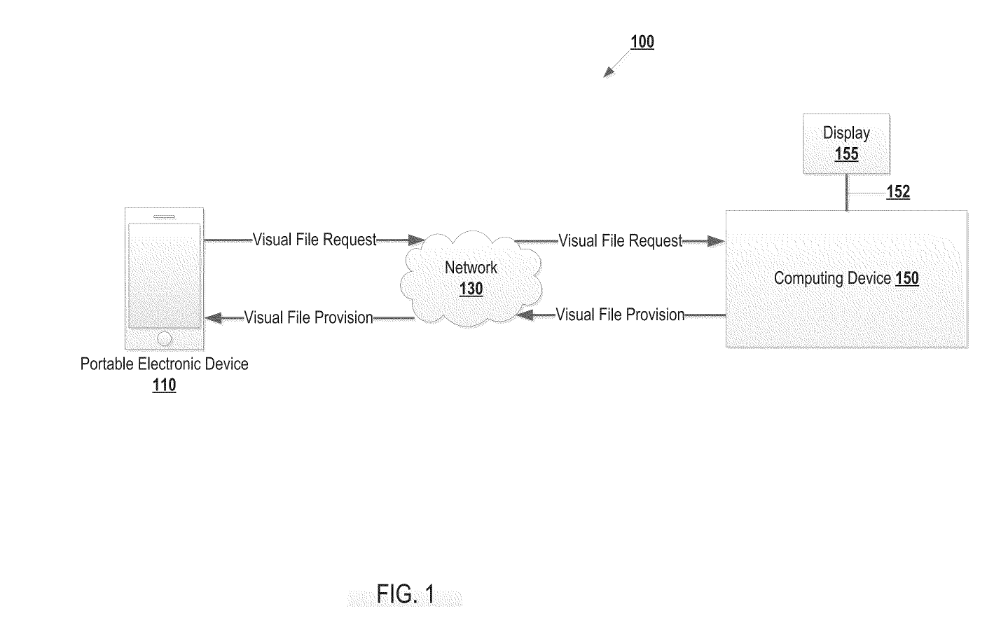

Beginning first with FIG. 1, a block diagram shows a system 100 for wirelessly transmitting a file from a computing device 150 in response to a request from a portable electronic device 110, in accordance with various embodiments. The system 100 includes, but is not limited to, a portable electronic device 110, a computing device 150, and a network 130. The portable electronic device 110, except for the visual file request feature of the present disclosure, may be any type of portable computing device adapted to transmit and receive data, such as a laptop computer, a tablet computer, a handheld device, a portable web-enabled appliance, a gaming device, a mobile phone, a smartphone, an eBook reader, a personal data assistant, or any computing device operable to communicate over the network 130. According to embodiments, the portable electronic device 110 may be adapted to display an image of a file stored or otherwise hosted at the computing device 150. In various embodiments, the displayed image may be an image of a display 155, coupled with the computing device 150, that is to present a representation of the file. The file may be any digital file, document, or similar resource—e.g., a text document, an image file, a video file, an audio file, or essentially any other type of digital file suitable to have a representation of the file presented at the display 155. For example, an application at the computing device 150 may be a set of instructions adapted to present a text document, present a digital image, track information associated with an audio file, etc. According to embodiments, the portable electronic device 110 may be coupled with or have integrated therein a camera adapted to capture the representation of the file presented on the display 155. The portable electronic device 110 may include a visual file request feature to request the file from the computing device 150 over the network 130.

The portable electronic device may be adapted for intersystem communication across a network 130. The network 130 may be a public or private network, and/or a combination of different types of networks. In many embodiments, the network 130 may be a wireless network. The network 130 may be implemented as a local area network (“LAN”), a wide area network (“WAN”) such as the Internet, a personal area network (“PAN”), a peer-to-peer network, a wireless cellular network (e.g., a cellular data network), or a combination thereof. In various embodiments, the network 130 may include one or more components that are instrumental in the implementation of the network 130, such as one or more access points, one or more routers, and other networking devices.

The network 130 may communicatively couple the portable electronic device 110 with a computing device 150. The computing device 150, except for the visual file provision feature of the present disclosure, may include any arrangement of hardware and software embodied in a computing device configured to wirelessly transmit one or more files to the portable electronic device 110 over the network 130. According to embodiments, the computing device 150 may be any type of computer system adapted to receive and transmit data, such as a personal computer (e.g., a desktop computer, laptop computer, server, or tablet computer), a workstation, a handheld device, a web-enabled appliance, a gaming device, a mobile phone, a smartphone, a personal data assistant, an eBook reader, or any other similar computing device.

The computing device 150 may be coupled with and/or have integrated there the display 155 through circuitry 152, which may be a bus or cable (e.g., a digital visual interface cable, a high-definition multimedia interface cable, etc.). In various embodiments, the computing device 150 may include an operating system, one or more software applications, and/or hardware (e.g., dedicated hardware) adapted to present a representation of the file at the display 155. Such an operating system, application, and/or hardware may be further adapted with the visual file provision feature of the present disclosure to transmit the file to and receive a request for the file from the portable electronic device 110 over the network 130.

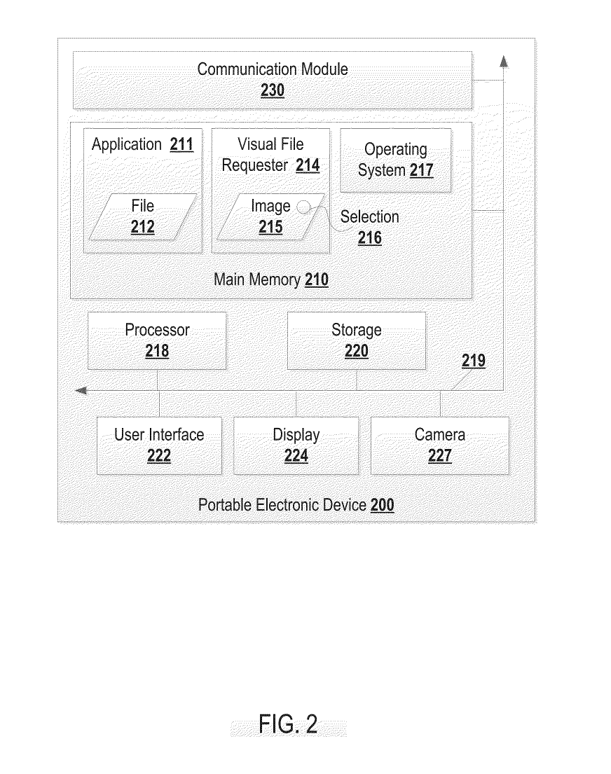

Turning now to FIG. 2, a block diagram illustrates a portable electronic device 200 that includes a visual file requester 214 adapted to wirelessly transmit an image and a description of a selection on the image to another computing device to request a file, in accordance with various embodiments. The portable electronic device 200 may be or may be included in the portable electronic device 110 of FIG. 1.

The portable electronic device 200 includes, but is not limited to, main memory 210, storage 220, processor 218, a user interface 222, a display 224, a communication module 230, and/or a camera 227. These components may be communicatively coupled through a bus 219. The bus 219 may be any subsystem adapted to transfer data within the portable electronic device 200. The bus 219 may include a plurality of computer buses as well as additional circuitry adapted to transfer data within the portable electronic device 200.

To communicate data with another computing device (not shown), the portable electronic device 200 includes a communication module 230. The communication module 230 may accept data across a network (not shown) from an external computing device to be processed by the portable electronic device 200. Correspondingly, the communication module 230 may transmit data across a network. The communication module 230 may be implemented in hardware, software, or a combination of the two and may include, for example, components such as a network card, network access controller, and/or other network interface controller(s). The communication module 230 is communicatively coupled with the processor 218, which executes instructions for the portable electronic device 200. In one embodiment, some or all of the instructions for the communication module 230 are executed by the processor 218.

In various embodiments, the communication module 230 may include circuitry adapted for one or more protocols or interfaces. For example, the communication module 230 may include circuitry adapted for at least one of wireless Internet and/or broadband access, such as a wireless LAN, World Interoperability for Microwave Access (“WiMax”), Wi-Fi, Evolved High-Speed Packet Access (“HSPA+”), and the like. According to embodiments, the communication module 230 may include circuitry adapted for one or more short-range communications, such as one or more of Bluetooth, Flashlinq, Radio Frequency Identification (“RFID”), Wi-Fi Direct, Infrared Data Association (“IrDA”), Near Field Communication (“NFC”), and the like. In some embodiments, the communication module 230 may include circuitry adapted for cellular voice and/or data communication according to at least one standard, as such as third Generation (“3G”), Long Term Evolution (“LTE”), LTE Advanced (“LTE-A”), and/or another standard promulgated by the third Generation Partnership Project (“3GPP”).

In various embodiments, the communication module 230 may include a service to pair or otherwise register the portable electronic device 200 with another computing device so that the portable electronic device 200 may transmit data to and receive data from the other computing device. In various embodiments, this pairing or registration may occur through short-range communication (e.g., Bluetooth, Wi-Fi Direct, NFC, etc.), wireless broadband (which may include transmission of data through an access point, router, etc.), a cellular data network (which may include an access point, node, etc.), and/or a combination of communication protocols. In various embodiments, the service is adapted to transmit one or more characteristics of the portable electronic device 200 to the other computing device, which may be used by the other computing device to adapt a file for the portable electronic device 200. The characteristic information transmitted via the service of the communication module 230 may include, for example, a resolution of the display 224, a version of the operating system 217, an indication of an application 211, or essentially any other information related to the portable electronic device 200.

As an additional means of receiving data, the portable electronic device 200 may include a user interface 222 to receive input from a user. The user interface 222 may allow a user to interact with the portable electronic device 200 through various means, according to different embodiments—e.g., the user interface 222 may be presented to a user on a display 224 as a graphical user interface or through a command line interface. To receive user input, the user interface 222 may be implemented in hardware, software, or a combination of the two and may include or may be communicatively coupled with one or more hardware devices suitable for user input (e.g., a keyboard, mouse, touch screen, or gesture recognition). Further, some or all of the instructions for the user interface 222 may be executed by the processor 218.

The processor 218 may be any processor suitable to execute instructions, such as instructions from the main memory 210. Accordingly, the processor 218 may be, for example, a central processing unit (“CPU”), a microprocessor, or another similar processor. In some embodiments, the processor 218 includes a plurality of processors, such as a dedicated processor (e.g., a graphics processing unit), a network processor, or any processor suitable to execute operations of the portable electronic device 200.

Coupled with the processor 218 is the main memory 210. The main memory 210 may offer both short-term and long-term storage and may in fact be divided into several units (including a unit located at the processor 218). The main memory 210 may be volatile, such as static random access memory (“SRAM”) and/or dynamic random access memory (“DRAM”), and may provide storage (at least temporarily) of computer-readable instructions, data structures, software applications, and other data for the portable electronic device 200. Such data may be loaded from the storage 220. The main memory 210 may also include cache memory, such as a cache located at the processor 218. The main memory 210 may include, but is not limited to, instructions related to the elements 211-214 that are to be executed by the processor 218: an application 211 adapted to present and/or request a file 212, a visual file requester 214 adapted to present an image and detect a selection of a location on the image at which a representation of the file is disposed, and an operating system 217.

In various embodiments, the operating system 217 is configured to initiate the execution of the instructions, such as instructions provided by the application 211 and/or the visual file requester 214. In particular, the operating system 217 may be adapted to serve as a platform for running the application 211 and/or visual file requester 214. The operating system 217 may be adapted to perform other operations across the components of the portable electronic device 200, including threading, resource management, data storage control, and other similar functionalities.

The operating system 217 may cause the processor 218 to execute instructions for the application 211 and/or visual file requester 214. The application 211 may include code representing instructions configured to present, process, or otherwise manipulate a file 212 by the portable electronic device 200. According to embodiments, the application 211 may be, for example, a word processing application, a media application, a graphics application, an editing application, a digital image presentation and/or manipulation application, a web browser application, a settings application (e.g., an application adapted to set a wallpaper, background, or the like), a messaging application (e.g., a short messaging service application, multimedia messaging service application, and/or instant messenger application), or essentially any other type of application adapted to present, process, or otherwise manipulate the file 212 (or a representation thereof). In various embodiments, the file 212 may be, for example, a text document, an image file, a video file, an audio file, or essentially any other type of digital file suitable to be processed by the application 211.

In some embodiments, the file 212 or a representation thereof may be presented by the application 211 at the display 224. The display 224 may be any suitable device adapted to graphically present data on a portable electronic device 200, such as a light-emitting diode (“LED”), an organic LED (“OLED”), a liquid crystal display (“LCD”), an LED-backlit LCD, or other display technology.

In embodiments, the file 212 is not immediately available to the application 211 at the portable electronic device 200 (e.g., the file 212 is not immediately stored at main memory 210 and/or storage 220). Rather, the file 212 may need to be requested from another computing device. To request the file from the other computing device, the portable electronic device 200 may include the visual file requester 214. The visual file requester 214 may be implemented in hardware, firmware, and/or software, such as in code representing instructions. According to the embodiment, the visual file requester 214 may be accessed by a user through input received at the user interface 222 and/or through the application 211 as a feature or function of the application 211 that is invoked thereby. The visual file requester 214 may present an image 215 on the display 224. The image 215 may include at least a part of another display coupled with the other computing device at which the file is stored. Accordingly, the image 215 may include a representation of at least a portion of the file stored on the other computing device. For example, the image 215 may include a portion of an image that is displayed on the other display of the other computing device.

According to one embodiment, the visual file requester 214 may be coupled with the camera 227. In response to invocation of the visual file requester 214, the camera 227 may present the image 215 on the display 224 of the portable electronic device 200. The portable electronic device 200 may be positioned by a user such that the camera 227 is directed to the other display of the other computing device while a representation of the desired file (stored at the other computing device) is presented on the display 224. While the image 215, including the representation of the desired file, is presented on the display 224, the visual file requester 214 may detect a selection 216 of a location on the image 215 through the user interface 222 (which may be a touch screen interface integrated with the display 224). The selection 216 of the location on the image 215 may be where a representation of the at least a portion of the desired file is at least partially disposed.

In one embodiment, the visual file requester 214 may be coupled with the storage 220. The visual file requester 214 may present the image 215 on the display 224 of the portable electronic device 200, for example, in response to detection of a selection by a user of an image stored in the storage 220 (e.g., the visual file requester 214 may cause a plurality of images to be presented on the display 224 and the visual file requester 214 may receive a selection of the image 215 through the user interface 222). While the image 215, including the representation of the desired file, is presented on the display 224, the visual file requester 214 may detect a selection 216 of a location on the image 215 through the user interface 222 (which may be a touch screen interface integrated with the display 224). The selection 216 of the location on the image 215 may be where a representation of the at least a portion of the desired file is at least partially disposed.

According to embodiments, the visual file requester 214 may be coupled with the communication module 230, which may include a transmitter. In response to the detected selection 216 on the image 215, the visual file requester 214 may cause the image 215 and a description of the selection 216 (e.g., pixel coordinates on the image 215) to be transmitted to the other computing device at which the file is stored via the communication module 230. The transmission of the image 215 and the description of the selection 216 may be or may be included in a request for the desired file from the other computing device. In various embodiments, the visual file requester 214 may include or may access an indication of the other computing device to which the image 215 and the description of the selection 216 are to be transmitted. For example, the communication module 230 may only be paired with one other computing device at the point at which the image 215 and the description of the selection 216 are to be transmitted, and therefore the visual file requester 214 may only have a single option of a computing device to which to transmit the image 215 and the description of the selection 216. In other embodiments, the visual file requester 214 may select the other computing device to which to transmit the image 215 and the description of the selection 216. For example, the visual file requester 214 may access metadata associated with the image 215 that identifies the other computing device coupled with the other display captured in the image 215. In another embodiment, the visual file requester 214 may include or may access an indication of the other computing device that is to receive the image 215 and the description of the selection 216 (which may be particularly beneficial in instances in which the portable electronic device 200 is not immediately paired or registered with the other computing device).

In embodiments, the communication module 230 may include a receiver. Based on the transmission of image 215 and the detected selection 216 on the image 215, the visual file requester 214 may receive, or may expect to receive, the desired file 212. According to various embodiments, the visual file requester 214 may provide the received file 212 to the application, which may be adapted to process the file 212 (e.g., present the file 212 on the display 224). The visual file requester 214 may include or may access an indication of the application through metadata associated with the file 212 and/or as a result of invocation by the application 211. In some embodiments, the visual file requester 214 may receive a message from the other computing device indicating that the desired file is not found or otherwise unreturnable. The visual file requester 214 may be adapted to relay an indication of the unreturned file to the application 211 and/or present such an indication at, for example, the display 224 (e.g., as an error message).

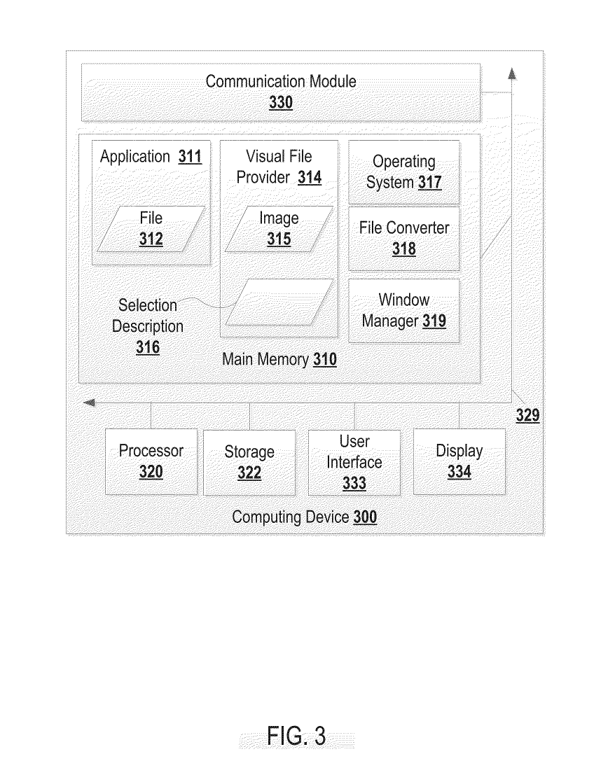

With respect to FIG. 3, a block diagram is shown illustrating a computing device 300 that includes a visual file provider 314 to identify a file 312 requested by another computing device (not shown), in accordance with various embodiments. The computing device 300 may be or may be included in the computing device 150 of FIG. 1, and the display 334 may be or may be included in the display 155.

The computing device 300 includes, but is not limited to, main memory 310, storage 322, processor 320, communication module 330, a user interface 333, and/or a display 334. These components may be communicatively coupled through a bus 329. The bus 329 may be any subsystem adapted to transfer data within the computing device 300. The bus 329 may include a plurality of computer buses as well as additional circuitry adapted to transfer data within the computing device 300.

To communicate data with another computing device (not shown), the computing device 300 includes a communication module 330. The communication module 330 may accept data across a network (not shown) from an external computing device (e.g., a portable electronic device) to be processed by the computing device 300. Correspondingly, the communication module 330 may transmit data across a network. The communication module 330 may be implemented in hardware, software, or a combination of the two and may include, for example, components such as a network card, network access controller, and/or other network interface controller(s). The communication module 330 is communicatively coupled with the processor 320, which executes instructions for the computing device 300. In one embodiment, some or all of the instructions for the communication module 330 are executed by the processor 320.

In various embodiments, the communication module 330 may include circuitry adapted for one or more protocols or interfaces. For example, the communication module 330 may include circuitry adapted for at least one of wireless Internet and/or broadband access, such as a wireless LAN, WiMax, HSPA+, and the like. According to embodiments, the communication module 330 may include circuitry adapted for one or more short-range communications, such as one or more of Bluetooth, Flashlinq, RFID, Wi-Fi Direct, IrDA, NFC, and the like. In some embodiments, the communication module 330 may include circuitry adapted for cellular voice and/or data communication according to at least one standard, as such as 3G, LTE, LTE-A, and/or another standard promulgated by 3GPP.

In various embodiments, the communication module 330 may include a service to pair or otherwise register another computing device with the computing device 300 so that the computing device 300 may transmit data to and receive data from the other computing device. In various embodiments, this pairing or registration may occur through short-range communication (e.g., Bluetooth, Wi-Fi Direct, NFC, etc.), wireless broadband (which may include transmission of data through an access point, router, etc.), a cellular data network (which may include an access point, node, etc.), and/or a combination of communication protocols. In various embodiments, the communication module 330 may include a service adapted to receive one or more characteristics of the other computing device. The characteristic information received via the service of the communication module 330 may include, for example, a resolution of a display of the other computing device, a version of an operating system of the other computing device, an indication of an application of the other computing device, or essentially any other information related to the other computing device.

As an additional means of receiving data, the computing device 300 may include a user interface 333 to receive input from a user. The user interface 333 may allow a user to interact with the computing device 300 through various means, according to different embodiments—e.g., the user interface 333 may be presented to a user on a display 334 as a graphical user interface or through a command line interface. To receive user input, the user interface 333 may be implemented in hardware, software, or a combination of the two and may include or may be communicatively coupled with one or more hardware devices suitable for user input (e.g., a keyboard, mouse, or touch screen). Further, some or all of the instructions for the user interface 333 may be executed by the processor 320.

The processor 320 may be any processor suitable to execute instructions, such as instructions from the main memory 310. Accordingly, the processor 320 may be, for example, a CPU, a microprocessor, or another similar processor. In some embodiments, the processor 320 includes a plurality of processors, such as a dedicated processor (e.g., a graphics processing unit), a network processor, or any processor suitable to execute operations of the computing device 300.

Coupled with the processor 320 is the main memory 310. The main memory 310 may offer both short-term and long-term storage and may in fact be divided into several units (including a unit located at the processor 320). The main memory 310 may be volatile, such as SRAM and/or DRAM, and may provide storage (at least temporarily) of computer-readable instructions, data structures, software applications, and other data for the computing device 300. Such data may be loaded from the storage 322. The main memory 310 may also include cache memory, such as a cache located at the processor 320. The main memory 310 may include, but is not limited to, instructions related to the elements 311-319 that are to be executed by the processor 320: an application 311 adapted to process (e.g., present) a file 312, a visual file provider 314 adapted to identify the file 312 based on a received image 315 and description of a selection 316 of a location on the image 315 at which a representation of the file 312 is disposed, operating system 317, a file converter 318, and/or a window manager 319.

In various embodiments, the operating system 317 is configured to initiate the execution of the instructions, such as instructions provided by the application 311 and/or the visual file provider 314. In particular, the operating system 317 may be adapted to serve as a platform for running the application 311 and/or visual file provider 314. The operating system 317 may be adapted to perform other operations across the components of the computing device 300, including threading, resource management, data storage control, and other similar functionalities.

The operating system 317 may cause the processor 320 to execute instructions for the application 311 and/or visual file provider 314. The application 311 may include code representing instructions configured to present, process, or otherwise manipulate a file 312 by the computing device 300. According to embodiments, the application 311 may be, for example, a word processing application, a media application, a graphics application, an editing application, a digital image presentation and/or manipulation application, a web browser application, a settings application (e.g., an application adapted to set a wallpaper, background, or the like), a messaging application (e.g., a short messaging service application, multimedia messaging service application, and/or instant messenger application), or essentially any other type of application adapted to present, process, or otherwise manipulate the file 312 (or a representation thereof). In various embodiments, the file 312 may be, for example, a text document, an image file, a video file, an audio file, or essentially any other type of digital file suitable to be processed by the application 311.

In some embodiments, the file 312 or a representation thereof may be presented by the application 311 at the display 334. The display 334 may be any suitable device adapted to graphically present data of the computing device 300, such as an LED, an OLED, an LCD, an LED-backlit LCD, a cathode ray tube (“CRT”), or other display technology. According to some embodiments, the display 334 may be removably coupled with the computing device 300 by, for example, a digital visual interface cable, a high-definition multimedia interface cable, etc.

In embodiments, the visual file provider 314 may be coupled with the communication module 330, which may include a receiver. The communication module 330 may be adapted to receive the image 315 and the description of the selection 316 and provide the same to the visual file provider 314. The visual file requester 214 may be implemented in hardware, firmware, and/or software, such as in code representing instructions. In some embodiments, the visual file provider 314 may operate as a background process that may, for example, passively listen and/or actively poll for the other device (which may be already paired or otherwise registered with the computing device 300) to transmit the image 315 and the description of the selection 316. According to various embodiments, the visual file provider 314 may be adapted to then identify the file 312 based on the received image 315 and the description of the selection 316. The visual file provider 314 may utilize one or more different approaches to identify the file 312 based on the image 315 and the description of the selection 316, according to various embodiments.

In one embodiment, the visual file provider 314 may be adapted to map the image 315 to content presented on the display 334 using image registration, feature detection, and/or other image processing methods associated with, for example, augmented reality. The visual file provider 314 may be coupled with the window manager 319. The window manager 319 may include instructions that track and/or control the placement and/or appearance of windows presented on the display 334. The visual file provider 314 may receive an indication of one or more locations of one or more windows on the display 334 from the window manager 319 (e.g., pixel coordinates of a window). The visual file provider 314 may be adapted to map the image 315 to a location and display 334 and determine a location on the display 334 that corresponds to the description of the selection 316 (e.g., by translating pixel coordinates of the description of the selection 316 to pixel coordinates on the display 334). The visual file provider 314 may then match the determined location on the display 334 that corresponds to the description of the selection 316 with an application 311 contained in a window at the determined location on the display 334, as indicated by the window manager 319. Accordingly, the visual file provider 314 may communicate with the application 311 to determine an identity of the file 312 open by the application 311.

In one embodiment, the visual file provider 314 may be adapted to access data about one or more files (e.g., metadata) and compare or otherwise match that data with a representation of the file 312, indicated by the description of the selection 316 included with the image 315. For example, the visual file provider 314 may use feature detection to extract features on the image indicated by the description of the selection and match the extracted features to stored data. In another embodiment, the visual file provider 314 may use optical character recognition to identify text characters and match those text characters to the text of a file 312 stored at the computing device 300.

According to embodiments, the communication module 330 may include a transmitter. Based on the identification of the file 312 (and, therefore, based on the reception of the image 315 and the description of the selection 316), the visual file provider 314 may cause the identified file 312 to be transmitted to the other computing device (e.g., the computing device from which the image 315 and the description of the selection 316 are received). In various embodiments, the visual file provider 314 may include or may access an indication of the other computing device to which the file 312 is to be transmitted. For example, the communication module 330 may be paired with the other computing device from which the image 315 and the description of the selection 316 are received, and therefore the visual file provider 314 may access the indication of the computing device to which to transmit the file 312 based on the source of the image 315 and the description of the selection 316. In other embodiments, the visual file provider 314 may access metadata associated with the image 315 and/or the description of the selection 316 that identifies the other computing device.

In some embodiments, the visual file provider may include or may be coupled with a file converter 318. The file converter 318 may be hardware, firmware, and/or software, such as in code representing instructions. The file converter 318 may be configured to adapt one or more attributes associated with the file 312. For example, the file converter 318 may convert the file 312 from a first format to a second format—e.g., a text document may be converted to a Portable Document Format (“PDF”) document. The file converter 318 may adapt the file 312 to a different resolution, to a different display size, and/or for optimization on a specific operating system (e.g., a mobile operating system). Accordingly, presentation of the file 312 on the other computing device to which the file 312 is transmitted may be improved. In various embodiments, the visual file provider 314 may be adapted to invoke the file converter 318 prior to transmission of the file 312 and adapt the file 312 for presentation on the other computing device based on, for example, characteristics of the other computing device received during a pairing and/or registration operation.

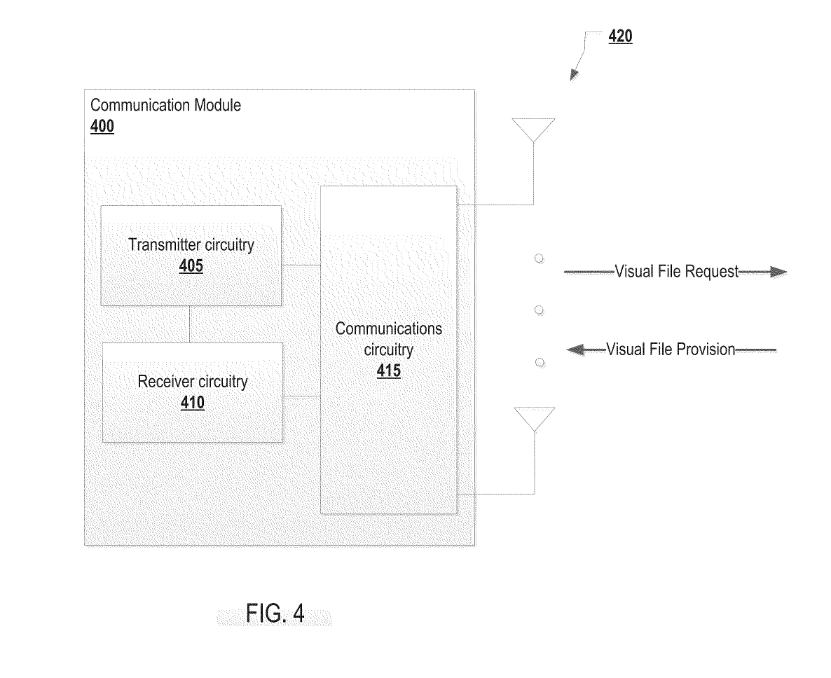

FIG. 4 illustrates a block diagram of a communication module 400 for wireless reception and transmission of files between computing devices, in accordance with various embodiments. The communication module 400 may be or may be included in the communication module 230 of FIG. 2 and/or the communication module 330 as illustrated in FIG. 4. The communication module 400 may include, but is not limited to, transmitter circuitry 405, receiver circuitry 410, communications circuitry 415, and/or one or more antennas 420 coupled with each at least as shown.

Briefly, the communications circuitry 415 may be coupled with the antennas 420 to facilitate over-the-air communication of signals to/from the communication module 400. Operations of the communications circuitry 415 may include, but are not limited to, filtering, amplifying, storing, modulating, demodulating, transforming, etc.

The transmitter circuitry 405 may be coupled with the communications circuitry 415 and may be configured to provide signals to the communications circuitry 415 for transmission by the antennas 420. In various embodiments, the transmitter circuitry 405 may be configured to provide various signal processing operations on the signal to provide the signal to the communications circuitry with appropriate characteristics. In some embodiments, the transmitter circuitry 405 may be configured to wirelessly transmit a file according to a visual file provision feature. In other embodiments, the transmitter circuitry 405 may be configured to receive and/or process a file that is received in response to a request, such as according to a visual file request feature.

The transmitter circuitry 405 may be configured to receive signals for transmission by the communications circuitry 415 (e.g., signals from another module or component (not shown) communicatively coupled with the communication module 400). In some embodiments, the transmitter circuitry 405 may be adapted to generate signals. Further, the transmitter circuitry 405 may be adapted to scramble, multiplex, and/or modulate various signals prior to transmission by the communications circuitry 415.

The receiver circuitry 410 may be coupled with the communications circuitry 415 and may be configured to receive signals for and/or from the communications circuitry 415, such as signals detected by one or more antennas 420. In some embodiments, the receiver circuitry 410 may be adapted to generate, adapt, or otherwise change signals. Further, the receiver circuitry 410 may be adapted to send received signals to another module or component (not shown) communicatively coupled with the communication module 400 so that data received from outside a device having the communication module 400 may utilize that data at the device. In some embodiments, the receiver circuitry 410 may be configured to wirelessly receive a file according to a visual file request feature, such as a file received in response to a request transmitted by the transmitter circuitry 405. In other embodiments, the receiver circuitry 410 may be configured to receive and/or process a request for a file, such as a request according to a visual file provision feature.

Some or all of the communications circuitry 415, transmitter circuitry 405, and/or the receiver circuitry 410 may be included in, for example, a communication chip and/or communicatively coupled with a printed circuit board.

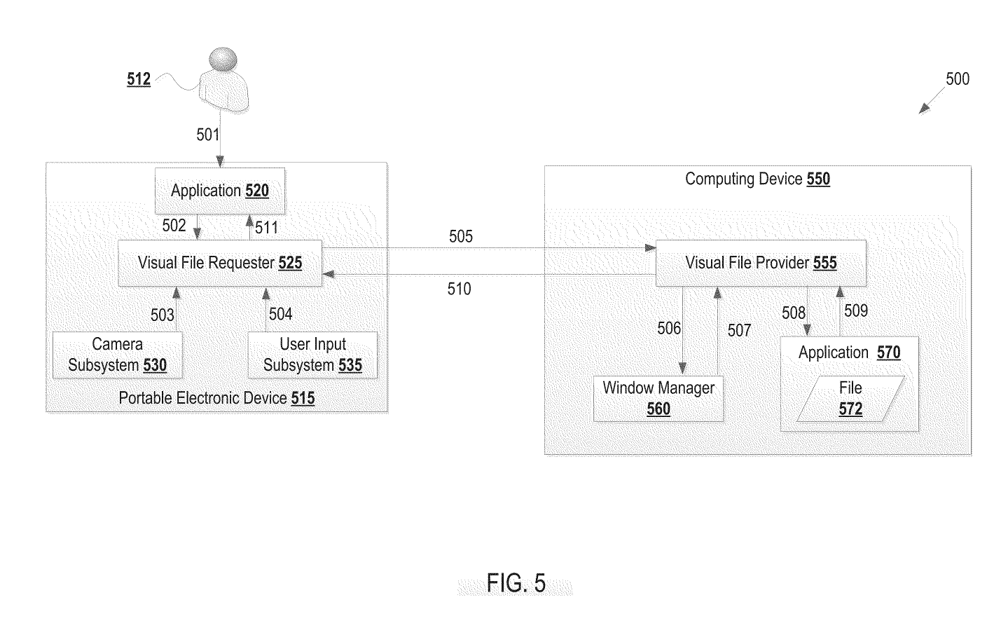

FIG. 5 shows a block diagram of wirelessly sharing a file between devices using an image of the file, in accordance with various embodiments. The portable electronic device 515 may be or may be included in the portable electronic device 110, and the computing device 550 may be or may be included in the computing device 150 of FIG. 1. In various embodiments, the application 520 may be or may be included in the application 211, the visual file requester 525 may be or may be included in the visual file requester 214, the camera subsystem 530 may be or may be included in the camera 227, and/or the user input subsystem 535 may be or may be included in the user interface 222 of FIG. 2. In various embodiments, the application 570 may be or may be included in the application 311, the visual file provider 555 may be or may be included in the visual file provider 314, and/or the window manager 560 may be or may be included in the window manager 319 of FIG. 3.

To begin, the user 512 may be interacting with an application 520 of a portable electronic device 515, such as a settings application (e.g., to select a wallpaper), a messaging service application, or essentially any other type of application adapted to receive user input. At operation 501, the portable electronic device 515 may detect, through the application 520, a selection that indicates the user 512 desires a file from another computing device. At operation 502, the application 520, in response, may invoke a visual file requester 525 to retrieve the file from the other computing device. In one embodiment, the visual file requester 525 may invoke a camera subsystem 530, which causes the portable electronic device 515 to present an image. At operation 503, the visual file requester 525 may cause an image of a display of the computing device 550 to be presented when the camera subsystem 530 is directed toward the computing device 550. The presented image may include a representation of the file 572, e.g., through an application 570 of the computing device 550. In another embodiment of operation 503, a stored image may be accessed from a storage (not shown) and presented to the user 512. At operation 504, a user input subsystem 535 (e.g., a touch screen or other user interface) may detect input of the user 512. The user input may be a selection of a location on the image presented to the user 512 where at least a portion of a representation of the desired file 572 is disposed. In various embodiments, user input may also cause the camera subsystem 530 to capture the image having the representation of the desired file.

In various embodiments, the visual file requester 525 may cause the image and a description of the selection of the location on the image to be transmitted to the computing device 550. At operation 505, the image and the description of the selection of the location on the image may be received and/or processed by a visual file provider 555. At operation 506, the visual file provider 555 may interface with the window manager 560 to map the image to a display of the computing device 550 and determine a location on the display that corresponds to the received description of the selection. At operation 507, the window manager 560 may then provide, to the visual file provider 555, an indication of the application 570 that corresponds to the received description of the selection. At operation 508, the visual file provider 555 may access or send a request to the application 570 to return an indication of the file 572 that is open and/or is disposed at the received description of the location. In response, the application 570 may return the file 572, as shown at operation 509. At operation 510, the visual file provider 555 may cause the file 572 (or an adapted version of the file 572) to be transmitted to the portable electronic device 515. The visual file requester 525 may then provide the received file 572 to the application 520 so that the received file may be, for example, presented to the user 512 or otherwise processed by the application 520.

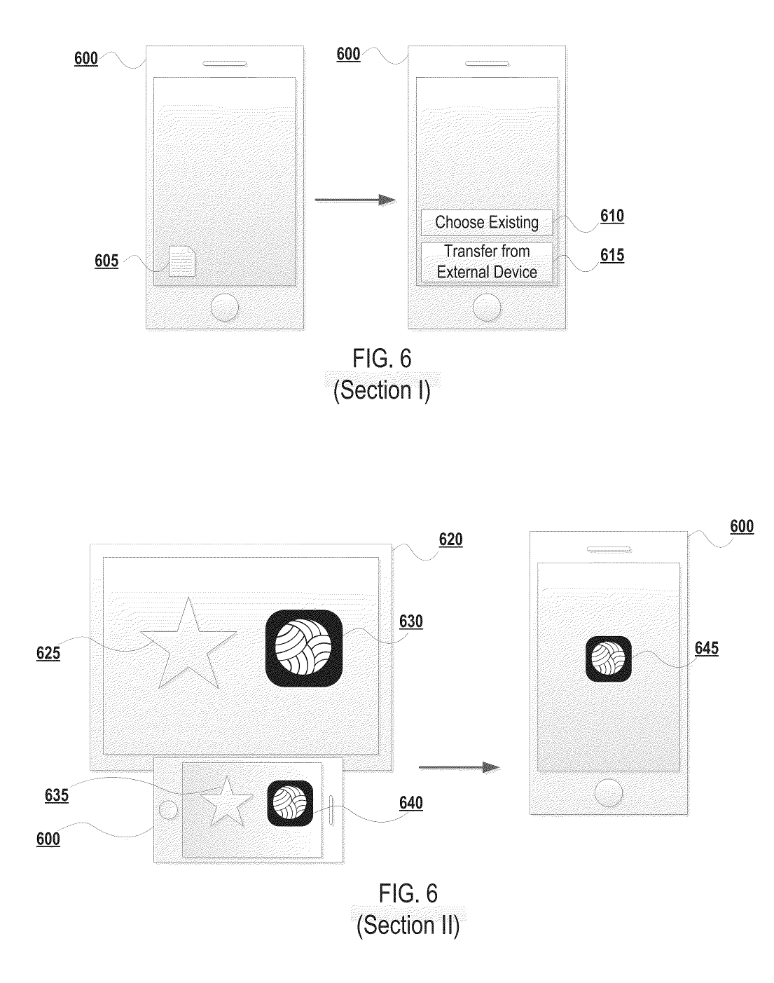

With respect to the top section of FIG. 6 (SECTION I), it illustrates a portable electronic device 600 having an application that is to invoke a visual file requester to wirelessly share a file, in accordance with various embodiments. The portable electronic device 600 may be or may be included in the portable electronic device 110 of FIG. 1. An application may cause an option 605 to be presented to a user on a display of the portable electronic device 600. Selection of the option 605 may indicate that a user would like for a file, such as a text document and/or media file, to be presented on the display of the portable electronic device 600. In various embodiments, selection of the option 605 may cause one or more selectable options 610-615 of sources for the file to be presented on a display of the portable electronic device 600. For example, the portable electronic device 600 may present an option 610 for an existing file that is stored in the portable electronic device 600. In embodiments, the portable electronic device 600 may present an option 615 for a file that is to be transferred from an external device, such as a personal computer or a tablet.

The lower section of FIG. 6 (SECTION II) illustrates the portable electronic device 600 that may wirelessly receive a desired file from another computing device 620 based on selection of the option 615 for a file that is to be transferred from an external device, in accordance with various embodiments. In some embodiments, the option 615 may invoke a camera (not shown) of the portable electronic device 600. In embodiments, a computing device 620 may present one or more files 625-630. As illustrated, the portable electronic device 600 may cause respective representations 635-640 to be presented on the portable electronic device 600 when the camera of the portable electronic device 600 is oriented at the displayed files 625-630 at the computing device 620. In another embodiment, the representations of the file 635-640 may be presented on the portable electronic device 600 as an image accessed from storage (not shown), rather than through a camera. The portable electronic device 600 may then detect a selection of a representation 640 of a file. Subsequently, the portable electronic device 600 may transmit a selection of a representation 640 of the file and the image having the representation 640 of the file to the computing device 620. The computing device 620 may identify a file corresponding to the selection of the representation 640 of the file and transmit the identified file to the portable electronic device 600. Based on the reception of the identified file, the portable electronic device 600 may present or otherwise process the received file 645 at the portable electronic device 600.

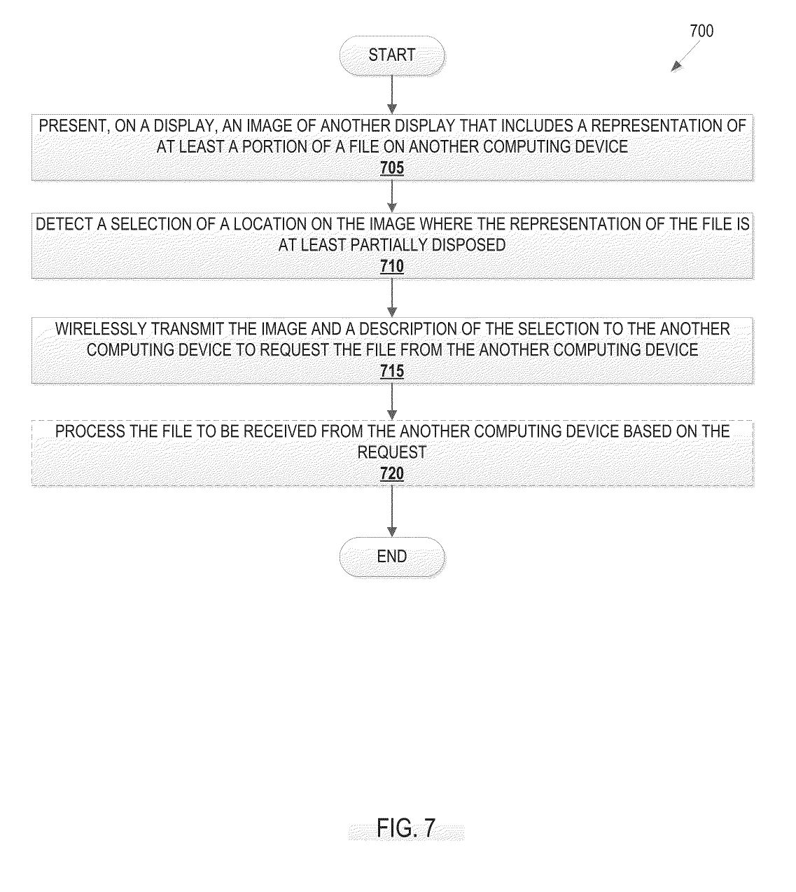

With respect to FIG. 7, a flow diagram illustrates a method 700 for requesting that a file be wirelessly transmitted from another computing device to a portable electronic device, in accordance with various embodiments. The method 700 may be performed by a portable electronic device, such as the portable electronic device 110 of FIG. 1. While FIG. 7 illustrates a plurality of sequential operations, one of ordinary skill would understand that one or more operations of the method 700 may be transposed and/or performed contemporaneously.

To begin, the method 700 may include operation 705 for presenting, on a display, an image of another display. According to embodiments, the presented image may include a representation of at least a portion of a file on another computing device. In one embodiment, the presented image may be provided by a camera that is instantly oriented at the other computing device while the other computing device displays at least a portion of the file. Alternatively, the presented image may be accessed from a storage. At operation 710, the method 700 may include detecting a selection of a location on the image. The selected location on the image may include a representation of the file or at least a partial representation of the file.

Subsequently, operation 715 may include wirelessly transmitting the image and a description of the selection to the other computing device. In embodiments, the wireless transmission of this data may be included in or may operate as a request for the file that is at least partially disposed at the selected location on the image. The method 700 may include an operation 720 for processing the file that is requested. In embodiments, the file may be received over a wireless network from the computing device to which the image and the description of the selection were transmitted.

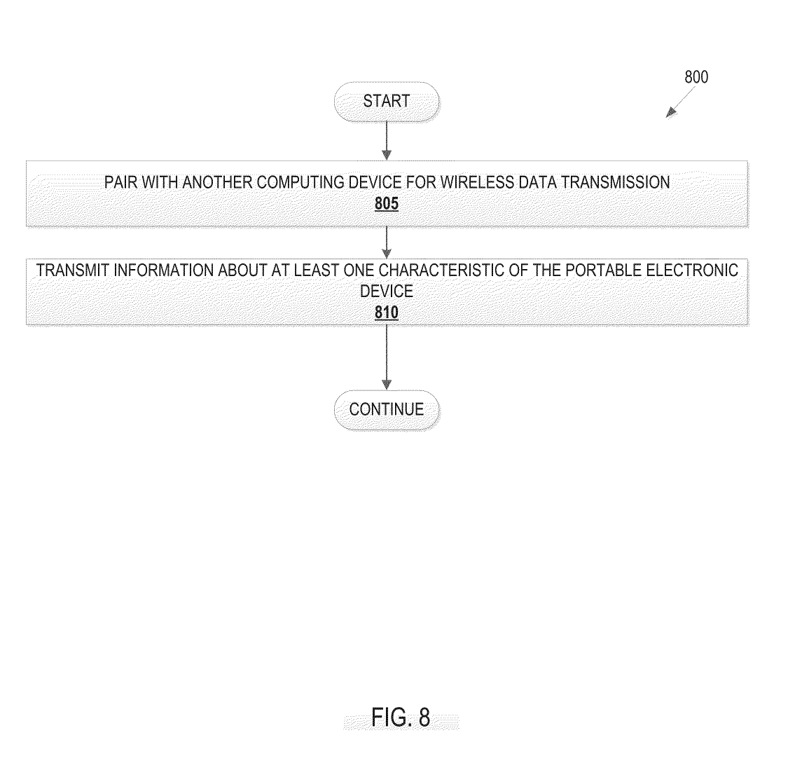

Turning to FIG. 8, a flow diagram illustrates a method 800 for pairing with and transmitting characteristics of a portable electronic device to another computing device to be used to adapt a file to be wirelessly transmitted from the other computing device to the portable electronic device, in accordance with various embodiments. The method 800 may be performed by a portable electronic device, such as the portable electronic device 110 of FIG. 1. While FIG. 8 illustrates a plurality of sequential operations, one of ordinary skill would understand that one or more operations of the method 800 may be transposed and/or performed contemporaneously.

To begin, the method 800 may include operation 805 for pairing with another computing device. This pairing may allow a computing device (e.g., a portable electronic device) performing the method 800 to wirelessly transmit to and/or receive data from the other computing device. The approach to pairing in operation 805 may vary according to embodiments. In various embodiments, the pairing operation may be a personal area network and/or device-to-device pairing operation, such as Bluetooth, Wi-Fi Direct, or another personal area network technique. In other embodiments, this operation 805 may include registering with the other computing device over another network that includes intermediary components, such as routers or access points. For example, this registration may include transmitting to and/or receiving from an identifier (e.g., an address) for the other computing device so that the other computing device is addressable over a WAN, LAN, wireless cellular network, or other network having a range typically greater than a PAN.

Operation 810 may include transmitting, to the other computing device, information about at least one characteristic of the portable electronic device performing the method 800. The transmitted information about the at least one characteristic may include, for example, information about a resolution of a display of the portable electronic device, a version of the operating system running at the portable electronic device, an indication of an application stored at the portable electronic device, or essentially any other information related to the portable electronic device. This information may be leveraged by the other computing device to adapt data for the portable electronic device.

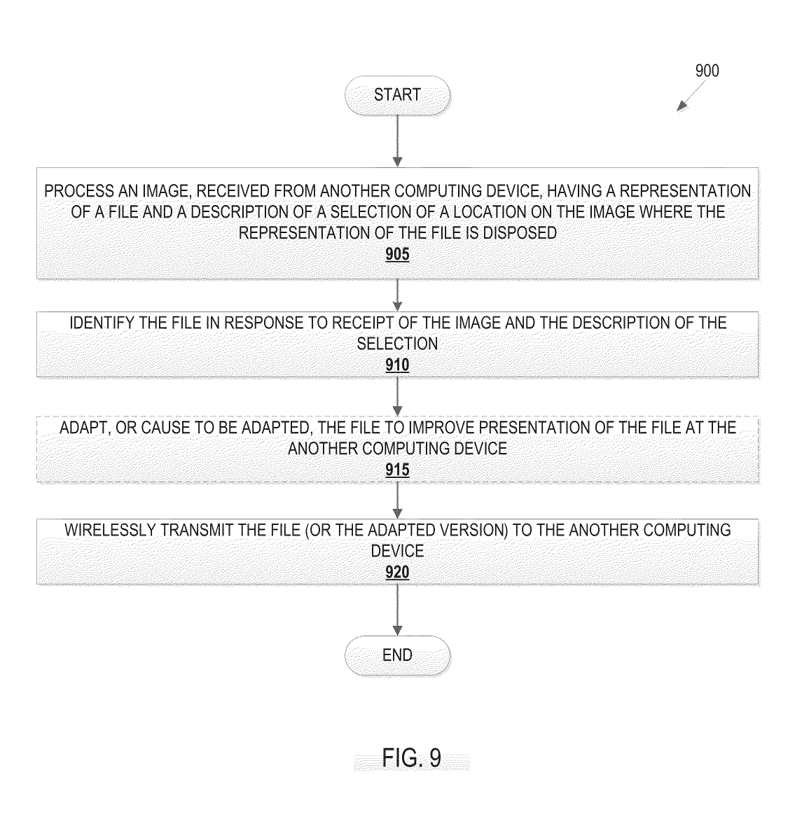

With reference to FIG. 9, a flow diagram shows a method 900 for identifying a requested file and wirelessly transmitting the identified file to another computing device, in accordance with various embodiments. The method 900 may be performed by a computing device, such as the computing device 150 of FIG. 1. While FIG. 9 illustrates a plurality of sequential operations, one of ordinary skill would understand that one or more operations of the method 900 may be transposed and/or performed contemporaneously.

The method 900 may begin with operation 905 for processing an image and a description of a selection. The image and the description of the selection may be received from another computing device (e.g., a portable electronic device) over a wireless network, such as a PAN, WAN, LAN, wireless cellular network, or the like. The image may include a representation of at least a portion of a file that is accessible by (e.g., stored at, addressable by, retrievable by, etc.) the computing device performing the method 900. The description of the selection may be associated with the image and may be a description of a location on the image at which at the representation of the file is at least partially disposed. The description of the selection may be, for example, coordinates (e.g., pixel coordinates, x-y coordinates) or another means for discerning a location on the image (e.g., one or more measurements). In various embodiments, the image and the description of the selection may be included in a request for a file that may be accessible by the computing device performing the method 900.

Based on the processing of the image and the description of the selection, operation 910 may include identifying a file accessible by the computing device performing the method 900. The file may be depicted in the representation of the file included in the image and referenced by the description of the selection. Accordingly, the file may be identified according to various techniques based on the representation of the file in the image and the description of the selection referencing the location of the file in the image. In various embodiments, the operation 910 may include operations for mapping the received image to content presented on a display coupled with a computing device through image registration, feature detection, and/or other image processing methods associated with, for example, augmented reality. In one embodiment, the operation 910 may include operations associated with accessing data about one or more files (e.g., metadata) and comparing or otherwise matching that data with the representation of the file, indicated by the description of the selection, included in the image.

Following identification of the file at operation 910, the method 900 may optionally include an operation 915 for adapting, or causing to be adapted, the identified file. In various embodiments, the other computing device from which the image and the description of the selection may be received may not feature the same capabilities or other characteristics as the computing device performing the method 900. Therefore, the operation 915 may be included to adapt the file to improve presentation of the file at the other computing device. In various embodiments, this adaptation may include, for example, adapting the file from a first format to a second format (e.g., from a text document to an image), adjusting a resolution, size, or other attribute of the file, or adapting the file for compatibility with a specific operating system, hardware parameter, or the like. In one embodiment, operation 915 may include operations for accessing a service (e.g., a program or service provided or a network) that causes the file to be adapted according to the characteristics of the other computing device. Subsequently, operation 920 may include wirelessly transmitting the file (or an adapted version of the file) to the other computing device that provided the image and the description of the selection.

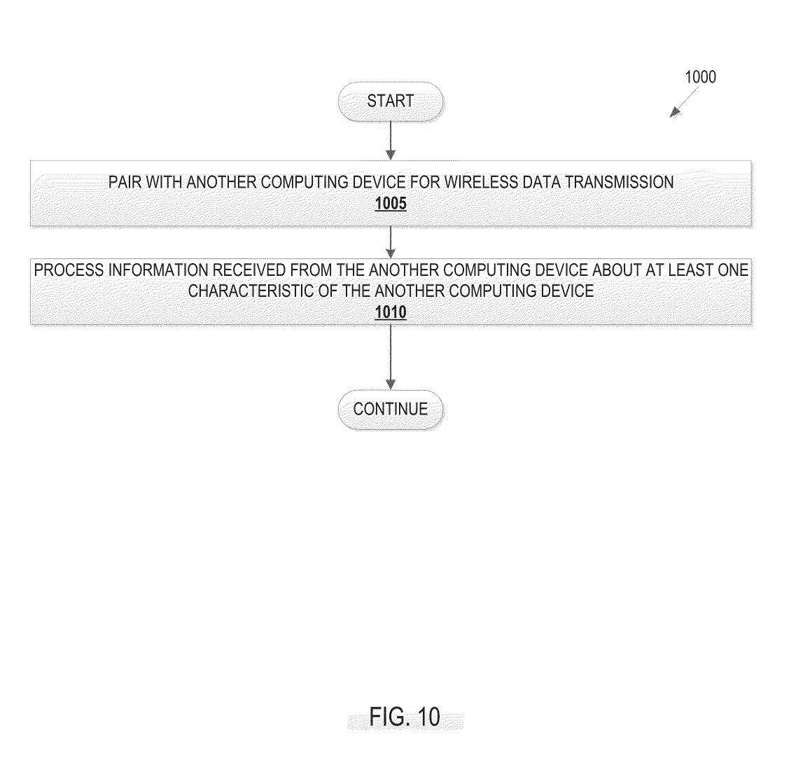

With reference to FIG. 10, a flow diagram shows a method 1000 for identifying a requested file and wirelessly transmitting the identified file to another computing device, in accordance with various embodiments. The method 1000 may be performed by a computing device, such as the computing device 150 of FIG. 1. While FIG. 10 illustrates a plurality of sequential operations, one of ordinary skill would understand that one or more operations of the method 1000 may be transposed and/or performed contemporaneously.

To begin, the method 1000 may include operation 1005 for pairing with another computing device (e.g., a portable electronic device). This pairing may allow a computing device performing the method 1000 to transmit to and/or receive data from the other computing device over a wireless network according to a visual file provider feature. This The approach to pairing in operation 1005 may vary according to embodiments. In various embodiments, the pairing operation may be a personal area network and/or device-to-device pairing operation, such as Bluetooth, Wi-Fi Direct, or another personal area network technique. In other embodiments, this operation 1005 may include registering the other computing device in response to a registration request from the other computing device received over a network that includes intermediary components, such as routers or access points. For example, this registration may include transmitting to and/or receiving from an identifier (e.g., an address) for the other computing device so that the other computing device is addressable over a WAN, LAN, wireless cellular network, or other network having a range typically greater than a PAN.

Operation 1010 may include processing information about at least one characteristic of the other computing device. This information may be received over a wireless network, for example, in connection with the pairing operation 1005 and, for example, according to a visual file request feature implement at the other computing device. The information about the at least one characteristic of the other computing device may include, for example, information about a resolution of a display of the other computing device, a version of the operating system running at the other computing device, an indication of an application stored at the other computing device, or essentially any other information related to the other computing device. This information may be leveraged by the computing device performing the method 1000 to adapt data for the other computing device (e.g., as shown at operation 915 of FIG. 9), for example, according to a visual file provision feature.

In various embodiments, example 1 may be a portable electronic device having a visual file request feature, the portable electronic device comprising: a display; a visual file requester, coupled with the display, to present on the display an image of another display of another computing device, wherein the image includes a representation of at least a portion of a file on the another computing device, and to detect a selection of a location on the image where the representation of the at least a portion of the file is at least partially disposed; and a transmitter, coupled with the visual file requester, to wirelessly transmit the image and a description of the selection to the another computing device to request the file from the another computing device. Example 2 may include the portable electronic device of example 1, wherein the file is one of a digital multimedia file, a digital image file, and a text file. Example 3 may include the portable electronic device of example 1, further comprising: a receiver, coupled with the visual file requester, to process the file to be received from the another computing device based on the request. Example 4 may include the portable electronic device of example 1, further comprising: a camera, coupled with the visual file requester, to capture the image of the another display of the another computing device for the visual file requester. Example 5 may include the portable electronic device of example 1, wherein the visual file requester is to access the image at a storage for the presentation on the display, and the portable electronic device further comprises: the storage, coupled with the visual file requester, to store the image of the another display of the another computing device. Example 6 may include the portable electronic device of any of examples 1-5, wherein the visual file requester is to present the image on the display in response to invocation by an application of the portable electronic device, and the portable electronic device further comprises: the application, coupled with the visual file requester, to detect user input that is to indicate a user would like to request a file from an external source, and to invoke the visual file requester. Example 7 may include the portable electronic device of any of examples 1-5, wherein the description of the selection of the location on the image includes coordinates corresponding to at least one pixel on the image. Example 8 may include the portable electronic device of any of examples 1-5, further comprising a communication service, coupled with the transmitter, to communicatively pair the portable electronic device with the another computing device. Example 9 may include the portable electronic device of example 8, wherein the communication service is further to transmit, to the another computing device, via the transmitter, information about at least one characteristic of the portable electronic device. Example 10 may include the portable electronic device of example 9, wherein the information about the at least one characteristic includes at least one of a resolution of the display, a version of an operating system of the portable electronic device, and an indication of an application that is to process a version of the requested file.

In various embodiments, example 11 may be a computing device having a visual file provision feature, the computing device comprising: a receiver to process an image, received from another computing device, having a representation or at least a portion of a file, and a description, received from the another computing device, of a selection of a location on the image where the representation of the at least a portion of the file is at least partially disposed; a visual file provider, coupled with the receiver, to identify the file in response to receipt of the image and the description of the selection; and a transmitter, coupled with the visual file provider, to wirelessly transmit the identified file or an adapted version of the identified file, to the another computing device on behalf of the visual file provider. Example 12 may include the computing device of example 11, wherein the computing device is one of a desktop computer, a laptop computer, and a tablet computer. Example 13 may include the computing device of example 11, wherein the another computing device is a portable electronic device that is one of a smartphone, a camera phone, a tablet computer, and a portable media player. Example 14 may include the computing device of example 11, further comprising a communication service, coupled with the visual file provider and the receiver, to communicatively pair the computing device with the another computing device. Example 15 may include the computing device of example 14, wherein the communicative service is to pair the computing device with the another computing device according to one of Bluetooth, Near Field Communication, or Wi-Fi Direct. Example 16 may include the computing device of any of examples 11-15, wherein the receiver is further to receive, from the another computing device, characteristic information associated with the another computing device, and the visual file provider is further to adapt the identified file, or cause the identified file to be adapted, based on the received characteristic information to improve presentation of the identified file at the another computing device. Example 17 may include the computing device of example 16, wherein the visual file provider is to adapt the file or cause the file to be adapted based on the received characteristic information, to change at least one of a format of the identified file, a resolution of the identified file, or a compression ratio of the identified file.

In various embodiments, example 18 may be one or more non-transitory computer system-readable media comprising computing device-executable instructions, wherein the instructions, in response to execution by a portable electronic device, cause the portable electronic device to: display an image of another display of another computing device, the image to include a representation of at least a portion of a file stored at the another computing device; detect a selection of a location on the image where the representation of the at least a portion of the file is at least partially disposed; and wirelessly transmit the image and a description of the selection of the location to the another computing device, to request the file from the another computing device. Example 19 may include the one or more non-transitory computer system-readable media of example 18, wherein the instructions, in response to execution by the portable electronic device, further cause the portable electronic device to: register with the another computing device. Example 20 may include the one or more non-transitory computer system-readable media of any of examples 19-20, wherein the instructions, in response to execution by the portable electronic device, further cause the portable electronic device to: transmit information associated with the portable electronic device to the another computing device. Example 21 may include the one or more non-transitory computer system-readable media of any of examples 19-20, wherein the instructions, in response to execution by the portable electronic device, further cause the portable electronic device to: process the file to be received from the another computing device based on the wireless transmission of the image and the description of the selection.

In various embodiments, example 22 may include one or more non-transitory computer system-readable media comprising computing device-executable instructions, wherein the instructions, in response to execution by a computing device, cause the computing device to: receive, from another computing device, an image of a display of the computing device that includes a representation of at least a portion of a file, and an indication of a user selection of a location on the image where the representation of the at least a portion of the file is at least partially disposed; identify the file, in response to receipt of the image and the indication of the user selection; and wirelessly transmit the identified file, or an adapted version of the identified file, to the another computing device to provide the file or the adapted version of the file to the another computing device. Example 23 may include the one or more non-transitory computer system-readable media of example 22, wherein the other computing device is a portable electronic device. Example 24 may include the one or more non-transitory computer system-readable media of any of examples 22-23, wherein the instructions, in response to execution by the computing device, further cause the computing device to: register the another computing device. Example 25 may include the one or more non-transitory computer system-readable media of any of examples 22-23, wherein the instructions, in response to execution by the computing device, further cause the computing device to: adapt or cause to be adapted, prior to the wireless transmission, the identified file based on one or more characteristics associated with the another computing device.

In various embodiments, example 26 may be a computer-implemented method for a visual file request feature, the method comprising: causing, by a computing device, display of an image of another display of another computing device, the image to include a representation of at least a portion of a file stored at the another computing device; detecting, by the computing device, a selection of a location on the image where the representation of the at least a portion of the file is at least partially disposed; and wirelessly transmitting, by the computing device, the image and a description of the selection of the location to the another computing device, to request the file from the another computing device. Example 27 may include the computer-implemented method of example 26, wherein the computing device is a portable electronic device. Example 28 may include the computer-implemented method of example 26, the method further comprising: registering, by the computing device, with the another computing device. Example 25 may include 29 the computer-implemented method of example 26, the method further comprising: transmitting, by the computing device, information associated with the computing device to the another computing device. Example 30 may include the computer-implemented method of any of examples 27-29, the method further comprising: receiving, by the computing device, the file from the another computing device based on the wireless transmission of the image and the description of the selection.

In various embodiments, example 31 may be a computer-implemented method for a visual file provision feature, the method comprising: receiving, by a computing device from another computing device, an image of a display associated with the computing device that includes a representation of at least a portion of a file, and an indication of a user selection of a location on the image where the representation of the at least a portion of the file is at least partially disposed; identifying, by the computing device, the file, in response to receipt of the image and the indication of the user selection; and wirelessly transmitting, by the computing device, the identified file, or an adapted version of the identified file, to the another computing device to provide the file or the adapted version of the file to the another computing device. Example 32 may include the computing-implemented method of example 31, wherein the computing device is one of a desktop computer, a laptop computer, and a tablet computer. Example 33 may include the computer-implemented method of example 31, wherein the other computing device is a portable electronic device. Example 34 may include the computer-implemented method of example 31, the method further comprising: registering, by the computing device, the another computing device. Example 35 may include the computer-implemented method of any of examples 31-34, the method further comprising: adapting or causing to be adapted, by the computing device prior to the wireless transmission, the identified file based on one or more characteristics associated with the another computing device.

In various embodiments, example 36 may be an apparatus, the apparatus comprising: means for causing a portable electronic device to display an image of another display of another computing device, the image to include a representation of at least a portion of a file stored at the another computing device; means for detecting a selection of a location on the image where the representation of the at least a portion of the file is at least partially disposed; and means for wirelessly transmitting the image and a description of the selection of the location to the another computing device, to request the file from the another computing device. Example 37 may include the apparatus of example 36, the apparatus further comprising: means for registering with the another computing device. Example 38 may include the apparatus of example 36, the apparatus further comprising: means for transmitting information associated with the portable electronic device to the another computing device.

In various embodiments, example 39 may be an apparatus, the apparatus comprising: means for receiving, from another computing device, an image of a display associated with a computing device that includes a representation of at least a portion of a file, and an indication of a user selection of a location on the image where the representation of the at least a portion of the file is at least partially disposed; means for identifying, by the computing device, the file, in response to receipt of the image and the indication of the user selection; and means for wirelessly transmitting, by the computing device, the identified file, or an adapted version of the identified file, to the another computing device to provide the file or the adapted version of the file to the another computing device. Example 40 may include the apparatus of example 39, the apparatus further comprising: means for adapting or causing to be adapted, prior to the wireless transmission, the identified file based on one or more characteristics associated with the another computing device.

Some portions of the preceding detailed description have been presented in terms of algorithms and symbolic representations of operations on data bits within a computer memory. These algorithmic descriptions and representations are the ways used by those skilled in the data processing arts to most effectively convey the substance of their work to others skilled in the arts. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

Embodiments of the invention also relate to an apparatus for performing the operations herein. Such a computer program is stored in a non-transitory computer-readable medium. A machine-readable medium includes any mechanism for storing information in a form readable by a machine (e.g., a computer). For example, a machine-readable (e.g., computer-readable) medium includes a machine- (e.g., a computer-) readable storage medium (e.g., read only memory (“ROM”), random access memory (“RAM”), magnetic disk storage media, optical storage media, flash memory devices).

The processes or methods depicted in the preceding figures can be performed by processing logic that comprises hardware (e.g., circuitry, dedicated logic, etc.), software (e.g., embodied on a non-transitory computer-readable medium), or a combination of both. Although the processes or methods are described above in terms of some sequential operations, it should be appreciated that some of the operations described can be performed in a different order. Moreover, some operations can be performed in parallel rather than sequentially.

Embodiments of the present invention are not described with reference to any particular programming language. It will be appreciated that a variety of programming languages can be used to implement the teachings of embodiments of the invention as described herein.

In the foregoing Specification, embodiments of the invention have been described with reference to specific exemplary embodiments thereof. It will be evident that various modifications can be made thereto without departing from the broader spirit and scope of the invention as set forth in the following claims. The Specification and drawings are, accordingly, to be regarded in an illustrative sense rather than a restrictive sense.

What is claimed is:

1. A portable electronic device having a visual file request feature, the portable electronic device comprising:
a display;
a visual file requester, coupled with the display, to present on the display an image of another display of another computing device, wherein the image includes a representation of at least a portion of a file on the another computing device, and to detect a selection of a location on the image where the representation of the at least a portion of the file is at least partially disposed; and
a transmitter, coupled with the visual file requester, to wirelessly transmit the image and a description of the selection to the another computing device to request the file from the another computing device.

2. The portable electronic device of claim 1, wherein the file is one of a digital multimedia file, a digital image file, and a text file.

3. The portable electronic device of claim 1, further comprising:
a receiver, coupled with the visual file requester, to process the file to be received from the another computing device based on the request.

4. The portable electronic device of claim 1, further comprising:
a camera, coupled with the visual file requester, to capture the image of the another display of the another computing device for the visual file requester.

5. The portable electronic device of claim 1, wherein the visual file requester is to access the image at a storage for the presentation on the display, and the portable electronic device further comprises:
the storage, coupled with the visual file requester, to store the image of the another display of the another computing device.

6. The portable electronic device of claim 1, wherein the visual file requester is to present the image on the display in response to invocation by an application of the portable electronic device, and the portable electronic device further comprises:
the application, coupled with the visual file requester, to detect user input that is to indicate a user would like to request a file from an external source, and to invoke the visual file requester.

7. The portable electronic device of claim 1, wherein the description of the selection of the location on the image includes coordinates corresponding to at least one pixel on the image.

8. The portable electronic device of claim 1, further comprising a communication service, coupled with the transmitter, to communicatively pair the portable electronic device with the another computing device.

9. The portable electronic device of claim 8, wherein the communication service is further to transmit, to the another computing device, via the transmitter, information about at least one characteristic of the portable electronic device.

10. The portable electronic device of claim 9, wherein the information about the at least one characteristic includes at least one of a resolution of the display, a version of an operating system of the portable electronic device, and an indication of an application that is to process a version of the requested file.

11. A computing device having a visual file provision feature, the computing device comprising:
a receiver to process an image, received from another computing device, having a representation or at least a portion of a file, and a description, received from the another computing device, of a selection of a location on the image where the representation of the at least a portion of the file is at least partially disposed;
a visual file provider, coupled with the receiver, to identify the file in response to receipt of the image and the description of the selection; and
a transmitter, coupled with the visual file provider, to wirelessly transmit the identified file or an adapted version of the identified file, to the another computing device on behalf of the visual file provider.

12. The computing device of claim 11, wherein the computing device is one of a desktop computer, a laptop computer, and a tablet computer.

13. The computing device of claim 11, wherein the another computing device is a portable electronic device that is one of a smartphone, a camera phone, a tablet computer, and a portable media player.

14. The computing device of claim 11, further comprising a communication service, coupled with the visual file provider and the receiver, to communicatively pair the computing device with the another computing device.

15. The computing device of claim 14, wherein the communicative service is to pair the computing device with the another computing device according to one of Bluetooth, Near Field Communication, or Wi-Fi Direct.

16. The computing device of claim 11, wherein the receiver is further to receive, from the another computing device, characteristic information associated with the another computing device, and the visual file provider is further to adapt the identified file, or cause the identified file to be adapted, based on the received characteristic information to improve presentation of the identified file at the another computing device.

17. The computing device of claim 16, wherein the visual file provider is to adapt the file or cause the file to be adapted based on the received characteristic information, to change at least one of a format of the identified file, a resolution of the identified file, or a compression ratio of the identified file.

18. One or more non-transitory computer system-readable media comprising computing device-executable instructions, wherein the instructions, in response to execution by a portable electronic device, cause the portable electronic device to:
display an image of another display of another computing device, the image to include a representation of at least a portion of a file stored at the another computing device;
detect a selection of a location on the image where the representation of the at least a portion of the file is at least partially disposed; and
wirelessly transmit the image and a description of the selection of the location to the another computing device, to request the file from the another computing device.

19. The one or more non-transitory computer system-readable media of claim 18, wherein the instructions, in response to execution by the portable electronic device, further cause the portable electronic device to:
register with the another computing device.

20. The one or more non-transitory computer system-readable media of claim 18, wherein the instructions, in response to execution by the portable electronic device, further cause the portable electronic device to:
transmit information associated with the portable electronic device to the another computing device.

21. The one or more non-transitory computer system-readable media of claim 18, wherein the instructions, in response to execution by the portable electronic device, further cause the portable electronic device to:
process the file to be received from the another computing device based on the wireless transmission of the image and the description of the selection.

22. One or more non-transitory computer system-readable media comprising computing device-executable instructions, wherein the instructions, in response to execution by a computing device, cause the computing device to:
receive, from another computing device, an image of a display of the computing device that includes a representation of at least a portion of a file, and an indication of a user selection of a location on the image where the representation of the at least a portion of the file is at least partially disposed;
identify the file, in response to receipt of the image and the indication of the user selection; and
wirelessly transmit the identified file, or an adapted version of the identified file, to the another computing device to provide the file or the adapted version of the file to the another computing device.

23. The one or more non-transitory computer system-readable media of claim 22, wherein the other computing device is a portable electronic device.

24. The one or more non-transitory computer system-readable media of claim 22, wherein the instructions, in response to execution by the computing device, further cause the computing device to:
register the another computing device.

25. The one or more non-transitory computer system-readable media of claim 22, wherein the instructions, in response to execution by the computing device, further cause the computing device to:
adapt or cause to be adapted, prior to the wireless transmission, the identified file based on one or more characteristics associated with the another computing device.
